(19) United States
(12) Patent Application Publication
(10) Pub. No.: US 2024/0270299 A1
(43) Pub. Date: Aug. 15, 2024

(54) PUSHCART CAPABLE OF SECURING DIFFERENT COMBINATIONS OF MODULES THERETO TO ENABLE USE FOR VARYING PURPOSES

(71) Applicant: Madlar Products, Inc., Ephrata, PA (US)

(72) Inventor: Jeffrey Myer, Lancaster, PA (US)

(21) Appl. No.: 18/414,285

(22) Filed: Jan. 16, 2024

Related U.S. Application Data
(60) Provisional application No. 63/439,011, filed on Jan. 13, 2023.

(51) Int. Cl. B62B 3/02

(52) U.S. Cl. CPC B62B 3/022

(57) ABSTRACT

A pushcart having a foldable L-shaped frame capable of securing different modules thereto. The frame includes a lower horizontal frame member and an upper vertical frame member. Both frame members include uniformly spaced cross bars. One of more cross bars may be utilized to secure different modules thereto. The modules can be changed based on the usage of the cart. The modules may be such that they fold up so that they can stay secured to the frame when the frame is folded for storage.

### BACKGROUND

Carts are utilized by individuals to hold items therein and enable the items to easily be transported by pushing (or pulling) the cart. For example, shopping carts are utilized in stores to enable a customer to put the items they are interested in purchasing therein as they browse the store and then take the items to their vehicle after purchasing. Strollers enable a toddler or child to sit therein and be transported and also possibly store some other items (e.g., diapers, wipes, toys). The various carts are designed for specific purposes. Individuals may utilize different carts for different purposes. However, this requires the purchase and storage of the multiple carts. Good quality carts are typically expensive so purchasing many is likely cost prohibitive. Cheaper carts are typically low quality and do not function adequately or last long.

Alternatively, one cart may be utilized for multiple purposes (multiuse cart), however a multiuse cart is not optimally configured for a plurality of purposes. Furthermore, multiuse carts are typically limited in that they cannot be folded and stored away without removing all attachments from a base frame. Moreover, multiuse carts typically do not allow for various different attachments to be interchangeably secured to a base to provide for modularity.

A high-quality cart that is maneuverable and can be used for various purposes is desired. A cart that includes a base frame and provides the ability to change attachments mounted thereto for different lifestyle uses is desirable. A cart that is collapsible, without the need to remove currently used attachments, for storage is desirable.

### BRIEF DESCRIPTION OF THE DRAWINGS

The features and advantages of the various embodiments will become apparent from the following detailed description in which:

FIG. 1A illustrates a front perspective view of an example foldable frame in an open configuration, according to one embodiment.

FIG. 1B illustrates a back perspective view of an example foldable frame in an open configuration, according to one embodiment.

FIG. 1C illustrates a side view of an example foldable frame in an open configuration, according to one embodiment.

FIG. 1D illustrates a top view of an example foldable frame in an open configuration, according to one embodiment.

FIG. 1E illustrates a front view of an example foldable frame in an open configuration, according to one embodiment.

FIG. 2 illustrates a close-up side view of example connectors for pivotally connecting the lower and upper frames, according to one embodiment.

FIGS. 3A-C illustrate a pair of front wheel assembles and a pair or read wheels and the connection of the same to the frame, according to one embodiment.

FIG. 4A illustrates a front perspective view of an example pushcart (foldable frame, wheels) in an open configuration, according to one embodiment.

FIG. 4B illustrates a back perspective view of an example pushcart (foldable frame, wheels) in an open configuration, according to one embodiment.

FIG. 4C illustrates a side view of an example pushcart (foldable frame, wheels) in an open configuration, according to one embodiment.

FIG. 4D illustrates a top view of an example pushcart (foldable frame, wheels) in an open configuration, according to one embodiment.

FIG. 4E illustrates a front view of an example pushcart (foldable frame, wheels) in an open configuration, according to one embodiment.

FIG. 5 illustrates a side view of an example pushcart having a large storage bin located on a lower frame, according to one embodiment.

FIG. 6A illustrates a perspective view of a rotatable front frame being secured to a lower frame, according to one embodiment.

FIG. 6B illustrates a close-up perspective view of the rotatable front frame secured to the lower frame, according to one embodiment.

FIG. 6C illustrates a perspective view of a clamp of the rotatable front frame of FIGS. 6A-B, according to one embodiment.

FIGS. 7A-E illustrate a series of side views of an example pushcart proceeding from a closed configuration to an open configuration, according to one embodiment.

FIG. 8A illustrates an example storage bin that could be utilized as a module for a pushcart, according to one embodiment.

FIG. 8B illustrates an example pet caddy that could be utilized as a module for a pushcart, according to one embodiment.

FIGS. 9A-C illustrate a series of side views of an example pushcart to show a process of adding additional items (modules) thereto, according to one embodiment.

FIGS. 10A-D illustrate a series of side views of an example pushcart to show a process of closing the cart without removing the modules connected thereto, according to one embodiment.

FIG. 11 illustrates a chair rack that could be utilized as a module, according to one embodiment.

FIGS. 12A-D illustrate a series of side views of the example pushcart to show a process of adding the chair rack thereto, according to one embodiment.

### DETAILED DESCRIPTION

A premium utility pushcart is provided that includes a foldable L-shaped frame capable of securing different items thereto. The frame includes a lower horizontal frame member and an upper vertical frame member. Both frame members include uniformly spaced cross bars. One of more cross bars may be utilized to secure items thereto or thereon. The items that are secured thereto can be changed based on the type of use you desire for the cart (the cart is modular). The items may be such that they fold up so that they can stay secured to the frame when the frame is folded for storage.

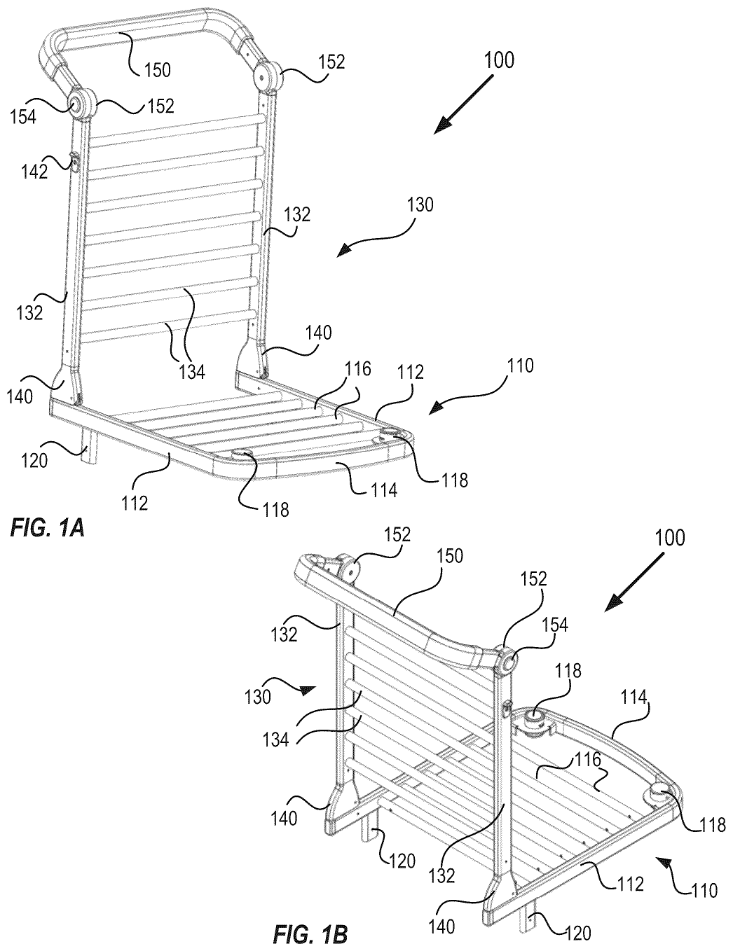

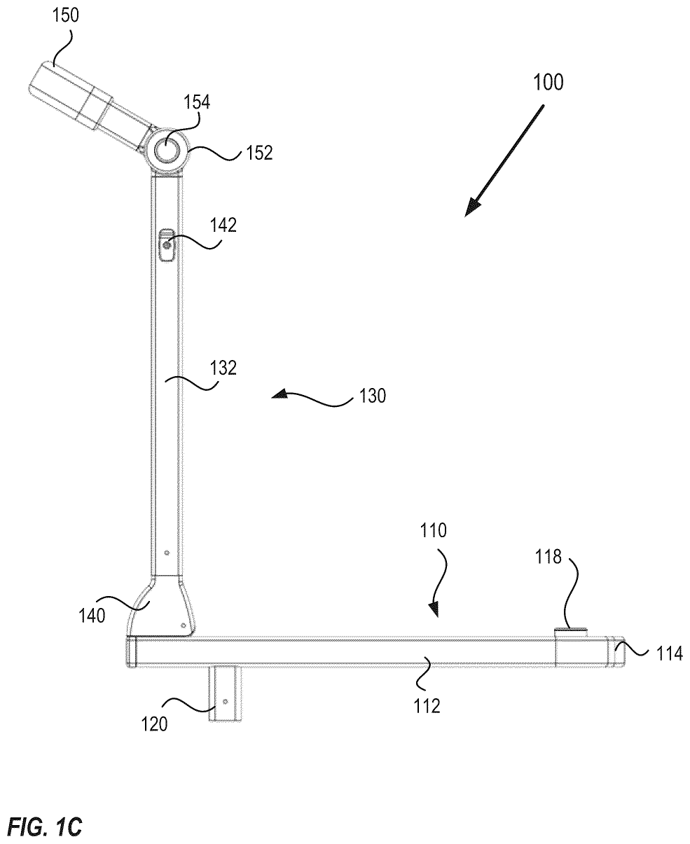

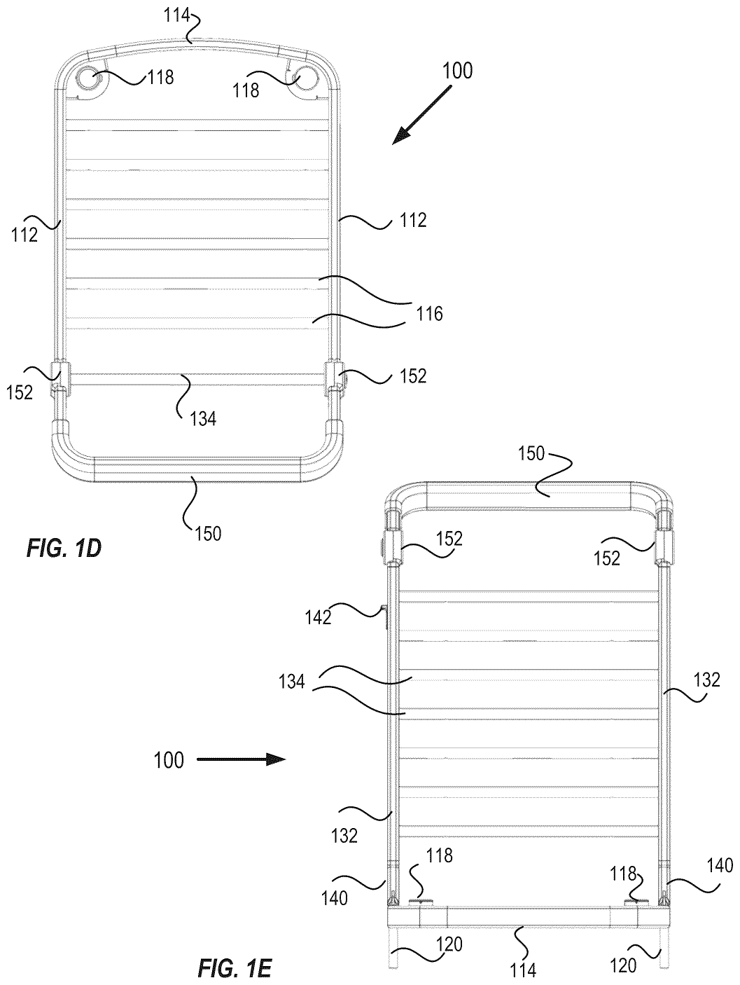

FIGS. 1A-E illustrate various views (front perspective, back perspective, side, top, front) of an example foldable frame 100, that may be utilized for a multi-use pushcart, in an open configuration. The frame 100 includes a lower horizontal frame 110 and an upper vertical frame 130. The lower frame 110 includes two side frame members 112 and a front frame member 114 connecting the side frame members 112 at a far end (end away from pivot point between frame members 110, 130) thereof. A plurality of cross bars 116 are located between the side frame members 112 and are securely connected thereto. According to one embodiment, the cross bars 116 are uniformly spaced apart along a length of the side frame members 112. Toward the far end of the lower frame 110 are a pair of receptacles 118 to receive a pair of wheel assemblies (e.g., front wheel assemblies). Extending downward in proximity to a near end (end at pivot point between frame members 110, 130) of the lower frame 110 are a pair of brackets 120. The brackets 120 are to secure a pair of wheels (e.g., rear wheels) thereto.

The upper frame 130 includes two side frame members 132 and a plurality of cross bars 134 located between the side frame members 132 and are securely connected thereto. According to one embodiment, the cross bars 134 are uniformly spaced apart along a length of the side frame members 132. The near end of the lower and upper frames 110, 130 are pivotally connected together with a pair of pivoting connectors 140. Each connector 140 receives a corresponding side frame 112, 132. The connectors 140 are capable of providing the frames 110, 130 in an open configuration where they are perpendicular to one another and a closed configuration where they are parallel to one another. The connectors 140 may enable the frames 110, 130 to pivot with respect to each other and then lock them in the open configuration. According to one embodiment, a release 142 may be provided to unlock the frames 110, 130 and enable them to be pivoted to the closed configuration. As illustrated, the release 142 is located on one of the side frame members 132 but is not intended to be limited thereto.

At a far end of the upper frame 130 is a handle 150. The handle 150 is connected to a far end of each of the side frame members 132. The handle 150 it to enable a user to push the cart. The handle 150 may be connected with pivoting connectors 152 that enable rotation of the handle 150 with respect to the upper frame 130. The rotation of the handle 150 may be based on who or what is pushing the cart. The handle 150 may be capable of being placed (locked) in different positions (e.g., predetermined positions). The pivoting connectors 152 may enable the handle 150 to be locked in an appropriate one of the predetermined positions. The pivoting connectors 152 may include a button 154 to unlock the handle from a position and enable rotation thereof.

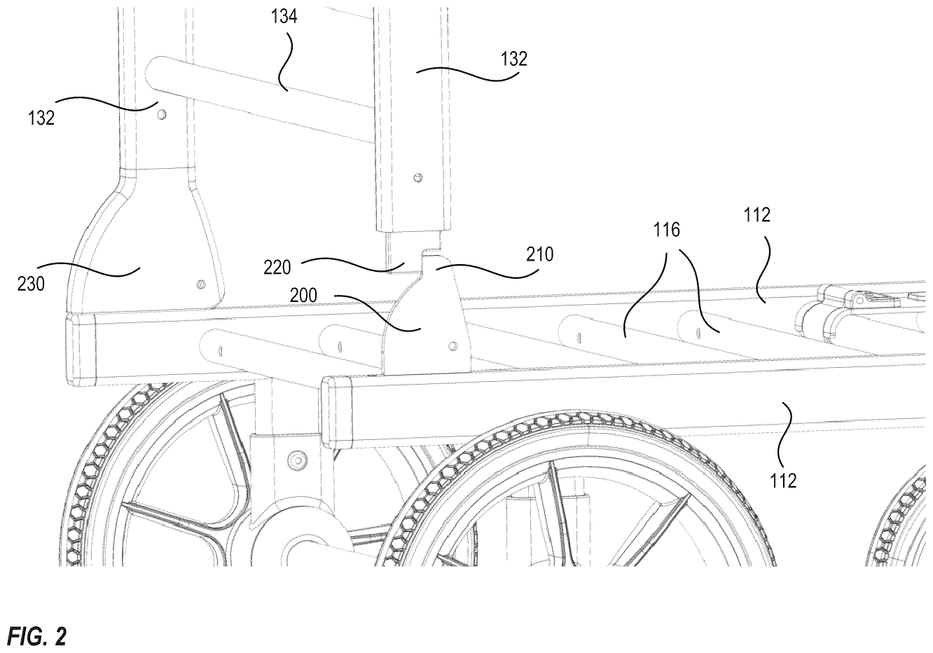

FIG. 2 illustrates a close-up side view of example connectors 140 for pivotally connecting the lower and upper frames 110, 130. The connectors 140 include a bracket 200 mounted to the side frame members 112 having a tab 210 extending upward therefrom, a tab 220 extending downward from the near end of the side frame members 132, and a cover 230. The cover 230 is placed over the bracket 200 and the tab 220 and ensures they stay secured together in close proximity. In an open configuration the tabs 210, 220 are in alignment with one another so that the lower and upper frames 110, 130 cannot pivot toward each other to the closed configuration. When the release 142 is activated the tab 420 is lifted up so that it is no longer aligned with the tab 210 and the lower and upper frames 110, 130 can pivot toward each other.

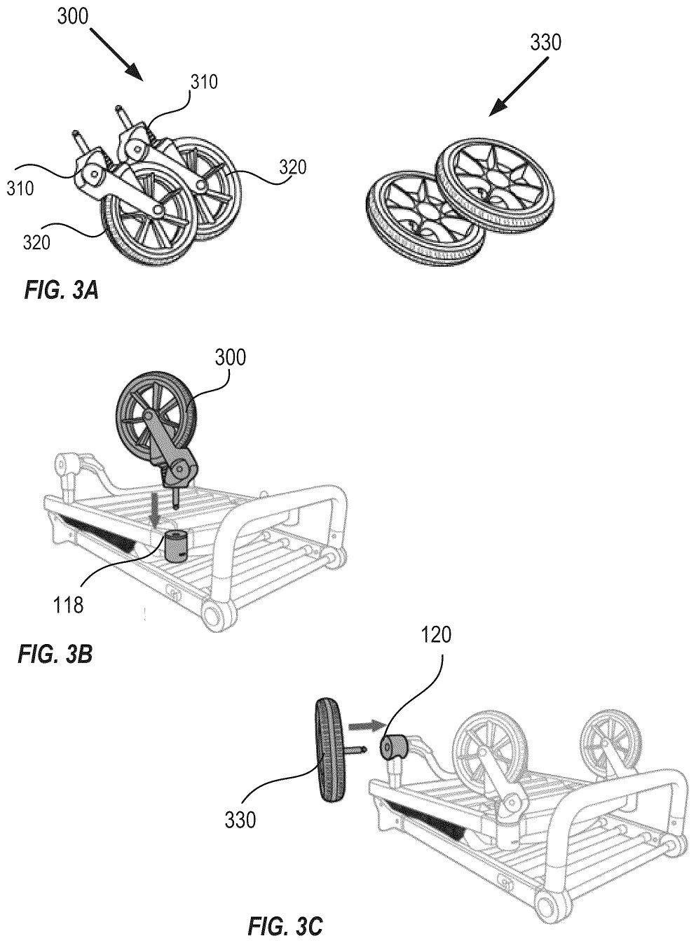

FIGS. 3A-C illustrate a pair of front wheel assembles 300 and a pair or read wheels 330 and the connection of the same to the frame 100. The front wheel assembles 300 include casters 310 and wheels 320 capable of rotating around the casters 310. The front wheel assembles 300 enable the frame 100 to be rolled in different directions. The real wheels 330 are simply wheels capable of rotating. As illustrated in FIG. 3B, a post of the caster 310 may be secured within the receptacle 118 of the frame. As illustrated in FIG. 3C, the rear wheels 330 may be secured to the tabs 120. An axel (not labeled) may be secured between the tabs 120 to ensure that the wheels spin at the same speed. The axel may include a brake (not labeled) for locking the axel and thus the rear wheels 330 to prevent the wheels 330 from rotating.

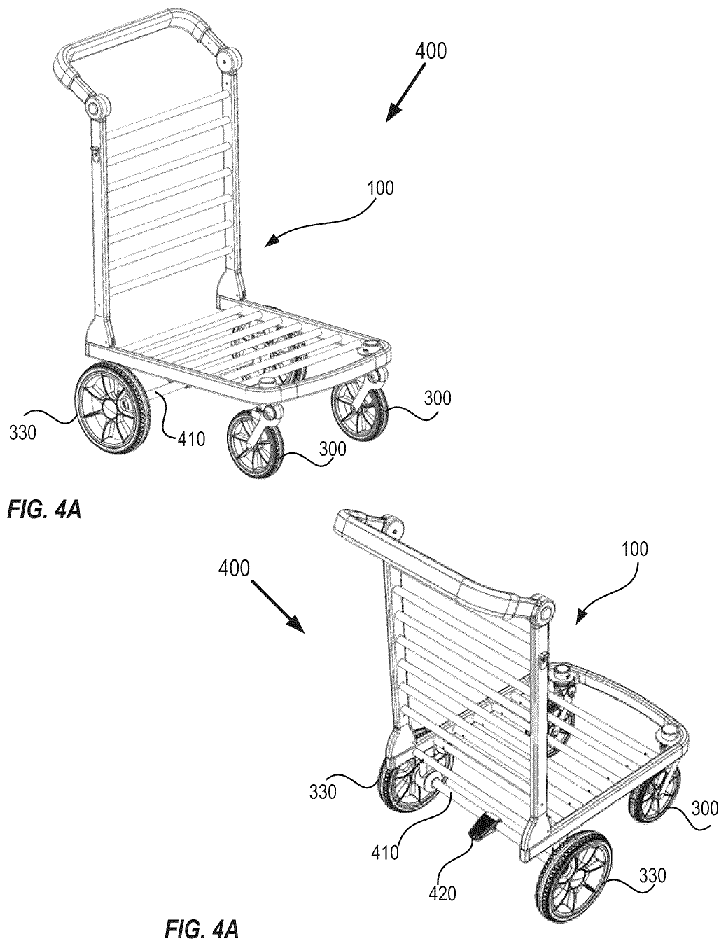

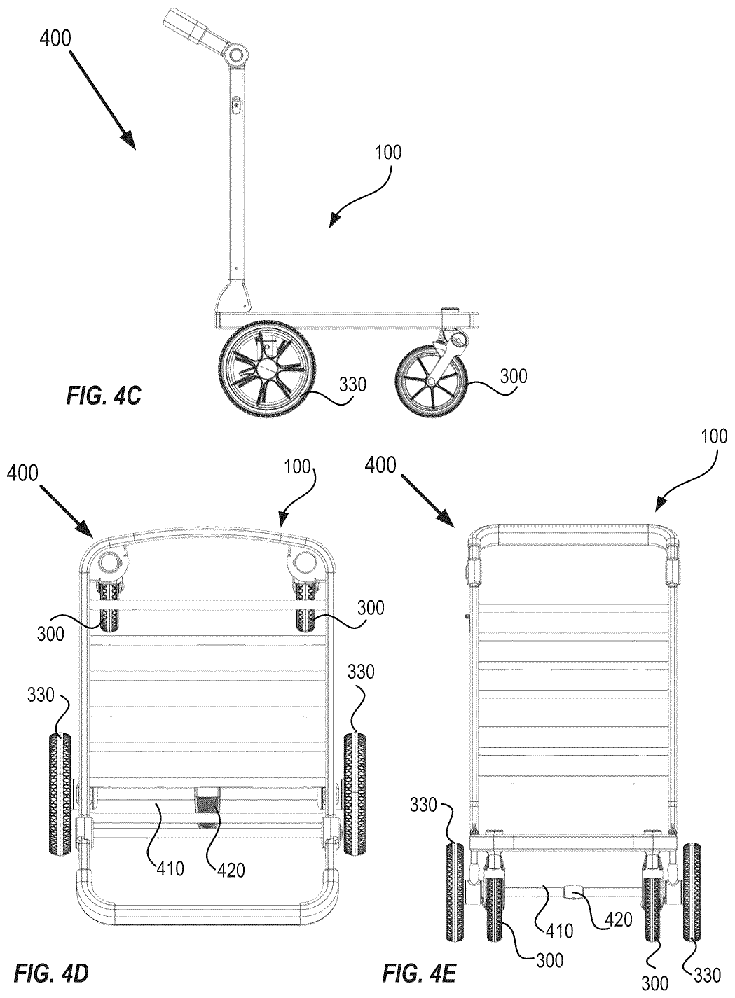

FIGS. 4A-E illustrate various views (front perspective, back perspective, side, top, front) of an example pushcart 400 including the example foldable frame 100 with the front wheel assemblies 300 and the rear wheels 330 attached thereto. It should be noted that for ease of illustration the various parts of the frame 100 are not labeled as they were discussed in detail with regard to FIGS. 1A-E. The front wheel assemblies 300 are connected to the receptacles 118 and the rear wheels 330 are connected to the brackets 120. An axle 400 is located between the rear wheels 330 and includes a brake 410 thereon.

The example pushcart 400 provides a frame and wheels to be able to transport different items. In order to customize the pushcart for different uses, different attachments may be secured to the frame thereof. The different attachments or combination of attachments customize the pushcart for different lifestyles. For example, the cart may be utilized by a user when they go shopping to carry various items they purchase (e.g., groceries, clothing). By way of another example, the cart could be used to transport a pet and various pet supplies. The cart could be utilized to carry beach supplies for a visit to the beach. The number of uses the cart is limitless. Accordingly, one or more attachments should be selected and connected to customize the cart for the use thereof. The number, type and organization of the attachments is based on the desired usage thereof.

In most uses, storage of various items may be required. Accordingly, an attachment that provides a large and secure storage bin may be desirable. According to one embodiment, a large storage bin is provided on the lower frame. According to one embodiment, the storage bin is capable of being collapsible and folded up with the cart so that it does not have to be removed for storage. The storage bin should be capable of being removed if the configuration of the pushcart is to be modified so that it does not include such a large storage bin.

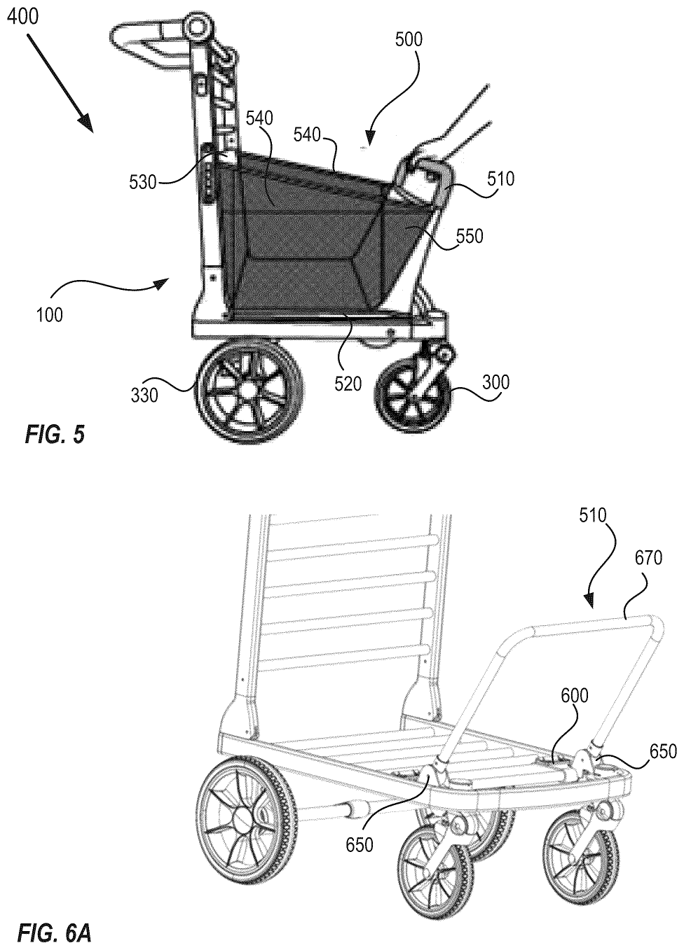

FIG. 5 illustrates a side view of an example pushcart 400 having a large storage bin 500 located on a lower frame. For ease of illustration the various parts of the frame 100 are not labeled. The storage bin 500 includes a rotatable front frame 510, a floor 520 capable of being secured to the lower frame, a back wall 530 capable of being secured to the upper frame, fabric (e.g., mesh) side walls 540 and a fabric (e.g., mesh) front wall 550. The floor 520 and the back wall 530 may include some type of connector (e.g., flaps, straps, hooks, clamps) to secure around one or more of the cross bars of a respective (upper, lower) frame. The fabric walls 540, 550 provide flexible walls that may expand based on what is stored therein. The fabric walls 540, 550 may be at least somewhat see through so that the contents therewithin are visible. The fabric walls 540, 550 may be secured to edges of the floor 520 and the back wall 530 and wrap around the front frame 510.

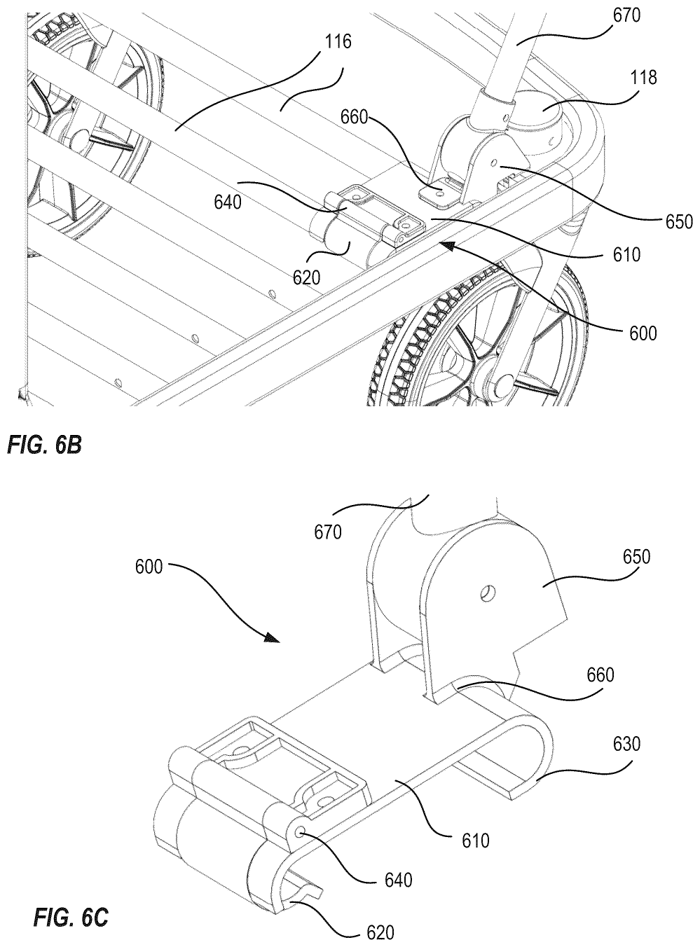

FIGS. 6A-6B illustrate perspective views of the rotatable front frame 510 utilized to provide support for the side walls and the front wall of the lower storage bin 500. The front frame 510 includes a pair of clamps 600, a pair or pivoting receptacles 650 and a frame 670. The clamps 600 are secured to a pair of cross bars 116. The pivoting receptacles 650 are connected to a far end of the clamps 600 and are capable of extending outward or falling back over the clamps 600. The frame 670 is U shaped and connects to each of the receptacles 650. FIG. 6C illustrates a perspective view of the clamp 600. The clamp 600 includes a main body 610, a first clip 620, a second clip 630, a first hinge 640 and a second hinge 660. The first and second clips 620, 630 are to secure respective sides of the clamp 600 to the cross bars 116. The first hinge 640 enables the first clip 620 to pivot to provide for engaging and disengaging the clip 620 to the cross bar 116. The second hinge 660 is to pivotally connect the receptacle 650 to the main body 610 and enable the receptacle 650 to pivot.

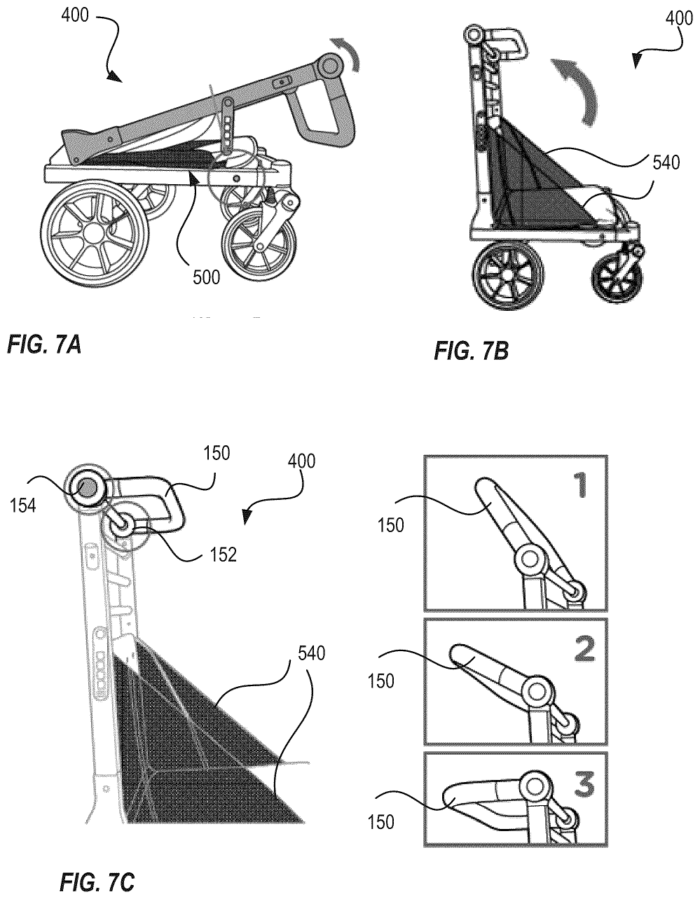

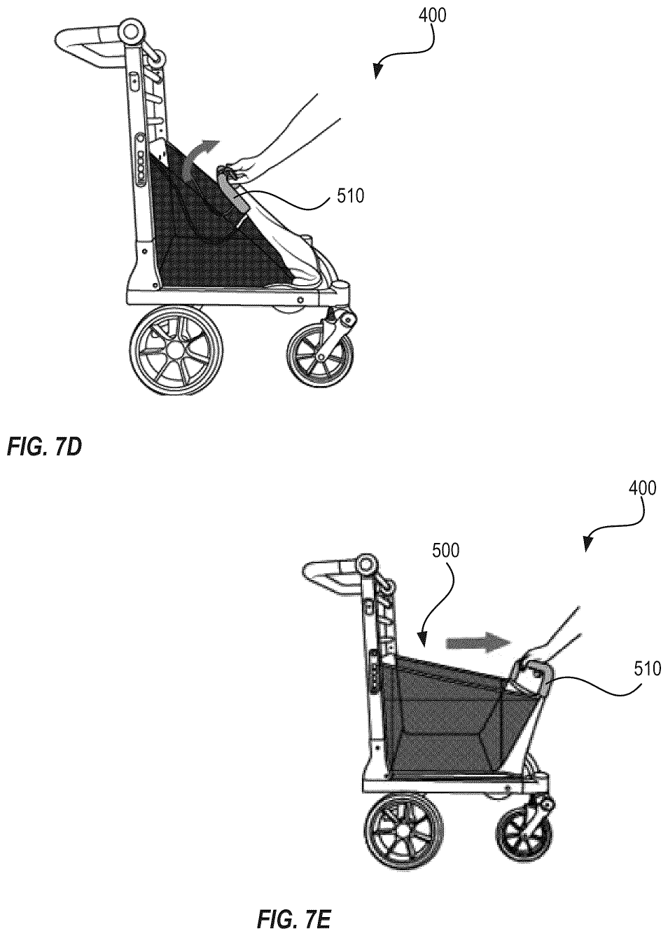

FIGS. 7A-E illustrate a series of side views of an example pushcart 400 showing a process of opening the cart 400. FIG. 7A illustrates the cart 400 being opened from a closed position where the bin 500 is collapsed. FIG. 7B illustrates the cart 400 after it has been opened and the upper frame is locked into position and the side walls 540 are partially in place. FIG. 7C illustrates the button 154 on the rotating connector 152 being depressed so that the handle 150 may be rotated out of the inward closed position to a desired position. The rotating connector 152 may be capable of locking the handle in a plurality of different positions. For example, 3 positions are illustrated. A first position is nearly straight upward from the upper frame, a second position is at an approximate 45-degree angle and the third position is at a 90-degree angle. FIG. 7D illustrates the rotatable front frame 510 being pulled upright to open the storage bin 500. FIG. 7E illustrates the cart 400 after the front frame 510 has been secured in place and the bin 500 is fully open.

Different modules may be secured to the upper vertical frame and extend over the cart to provide storage for different items above the storage bin 500. The different modules may include clamps 600 for securing the module to a plurality of cross bars. The clamps 600 may include a hinged receptacle for receiving a frame and holding the frame in an upright position (perpendicular to the upper vertical frame) or folding the frame downward (parallel to the upper vertical frame). The module may extend outward during use and be folded inward for storage.

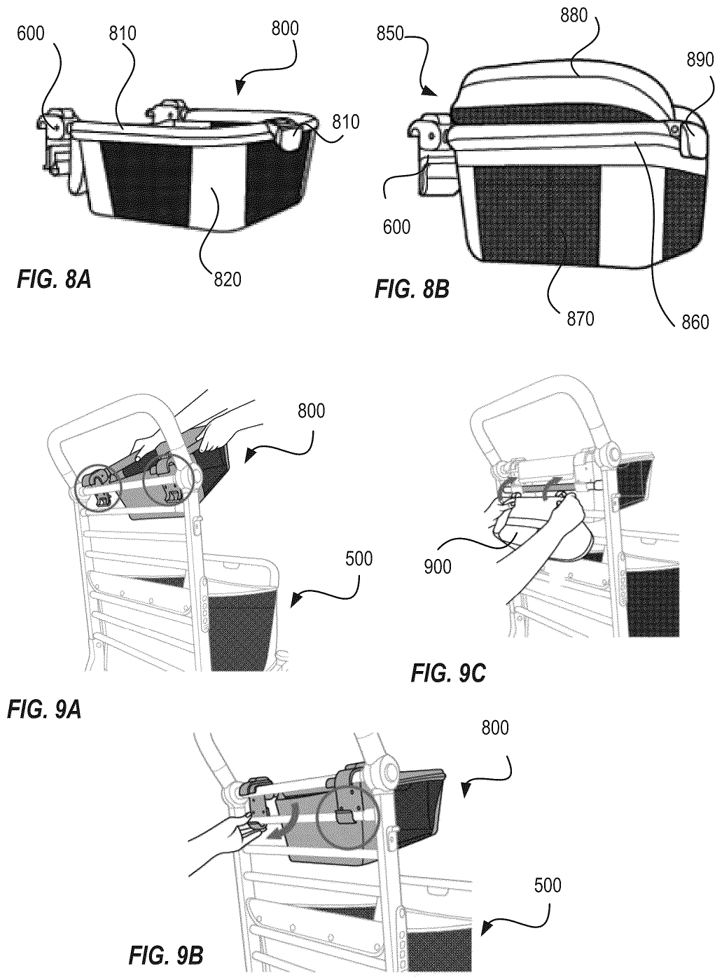

FIG. 8A illustrates a storage bin 800 that could be utilized as a module. The storage bin 800 includes a pair of clamps 600, an upper frame 810, and a body 820 extending from the frame 810. The storage bin 800 may include a button 830 to disengage the hinged receptacle of the clamp 600 to enable the basket 800 to pivot downward. FIG. 8B illustrates a pet caddy 850 that could be utilized as a module. The pet caddy 850 includes a pair of clamps 600, an upper frame 860, a body 870 extending downward from the frame 860 and a cover 880 secured to the frame 860. The cover 880 may be capable of opening and closing so as to enable a pet to be located and then secured therein. The pet caddy 850 may include a button 890 to disengage the hinged receptacle of the clamp 600 to enable the pet caddy 850 to pivot downward.

FIGS. 9A-C illustrate a series of side views of the example pushcart to show a process of adding additional items (modules) thereto. The modules are added above the storage bin 500. FIG. 9A illustrates upper clips (e.g., 630) of the clamps 600 of a storage bin 800 being secured to a first cross bar of the upper vertical frame. FIG. 9B illustrates lower clips (e.g., 610) of the clamps 600 being pivoted (e.g., via hinge around a second cross bar of the upper vertical frame. FIG. 9C illustrates an organizer 900 being connected to a back side of the upper vertical frame that would be accessible to a user pushing the cart. The organizer 900 may include a pair of clips (not labeled) that clip onto a cross bar.

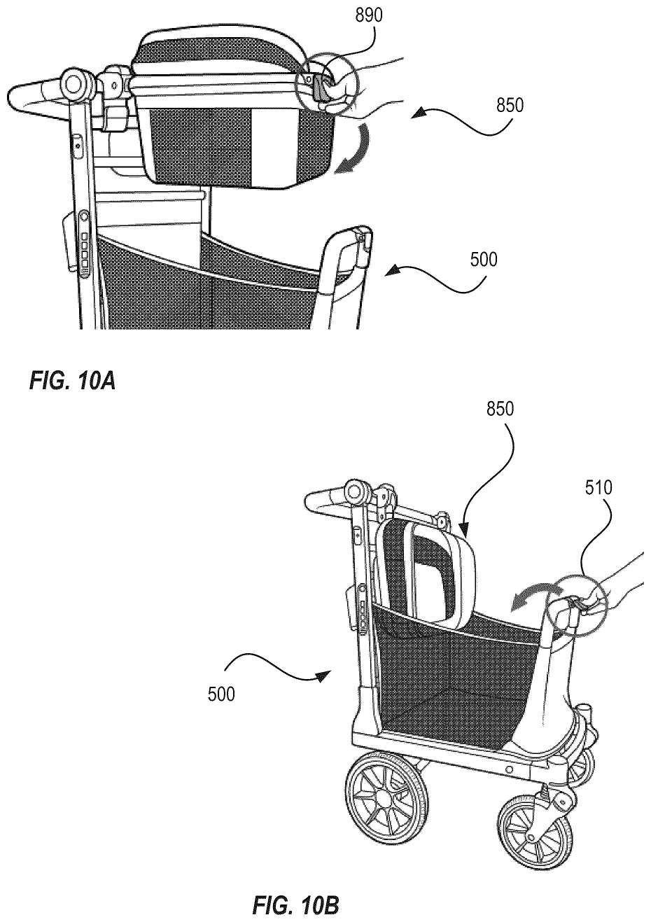

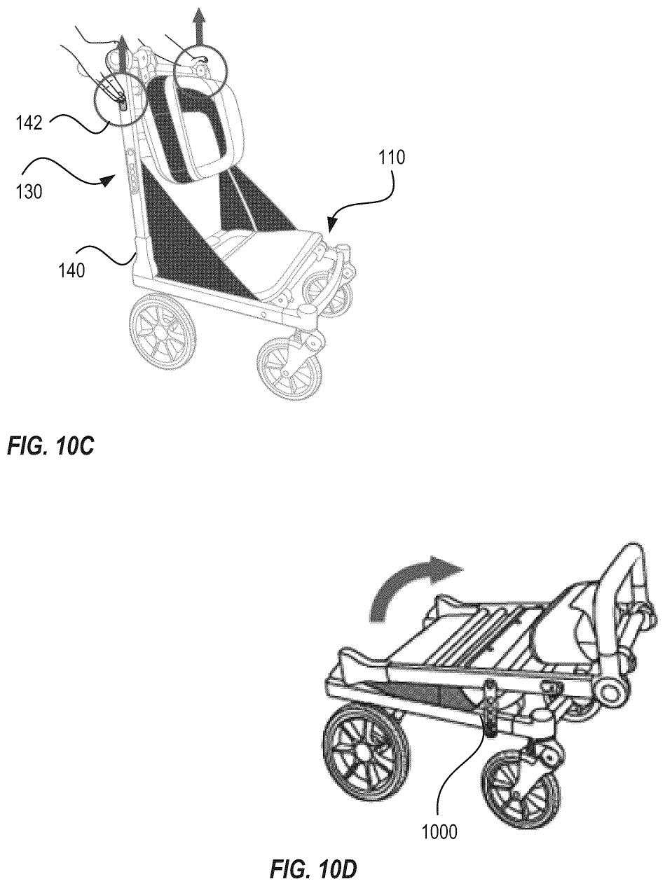

FIGS. 10A-D illustrate a series of side views of an example pushcart to show a process of closing the cart without removing the modules connected thereto. FIG. 10A illustrates the cart is initially operating with a pet module 850 above a storage bin 500. The button 890 on the pet module is depressed to disengage the hinged receptacle of the clamp and enable the pet module 850 to pivot back toward the upper vertical frame. FIG. 10B illustrates the routable front frame member 510 of the storage bin 500 being rotated inward. The frame member 510 may include a button that is depressed to disengage the hinged receptacle of the clamp. FIG. 10C illustrates the release 142 being engaged to disengage the connectors 140 and enable the upper frame 130 to be folded into the lower frame 110. FIG. 10D illustrates the cart after the upper frame has been folded down and is in a closed configuration where a strap 1000 may be utilized to secure it in the closed configuration.

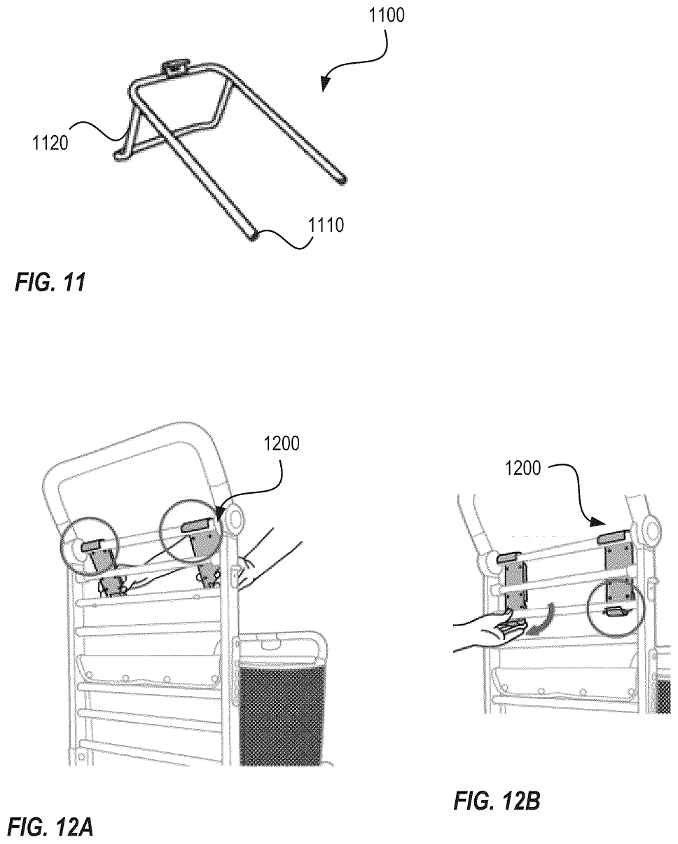

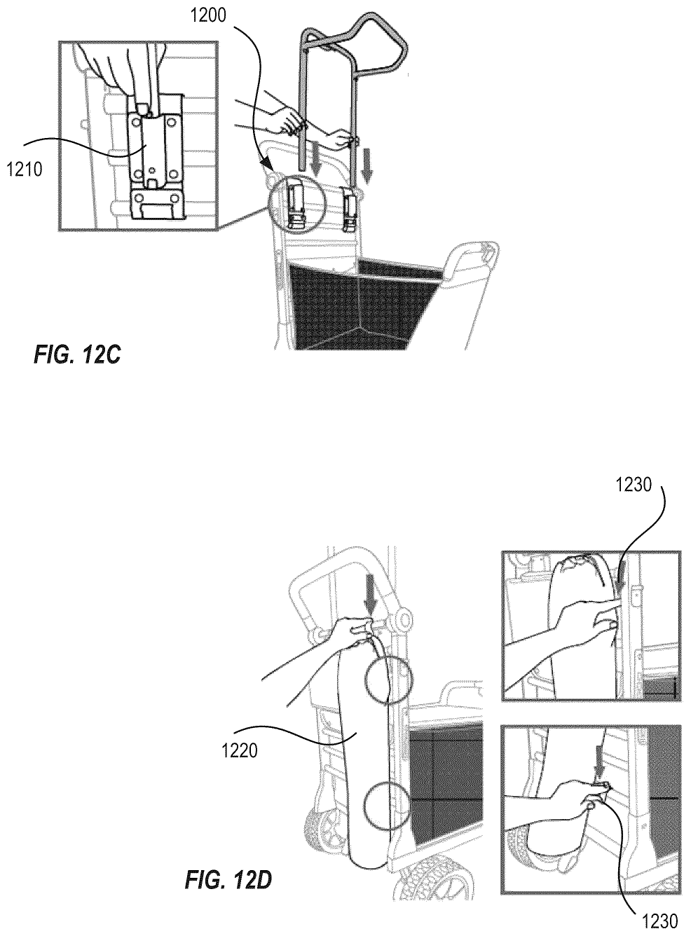

FIG. 11 illustrates a chair rack 1100 that could be utilized as a module. The chair rack 1100 includes a pair of legs 1110 for securing to the cart and a rack 1120 for holding chairs. While not illustrated the chair rack 1100 will include a pair of receptacles for receiving and securing the legs 1100. The receptacles may be formed in clamps similar to the clamps 600. FIGS. 12A-D illustrate a series of side views of the example pushcart to show a process of adding the chair rack 1100 thereto. FIG. 12A illustrates upper clips of the clamps of receptacles 1200 being secured to a first cross bar of the upper vertical frame. It should be noted that only the back side of the receptacle 1200 that includes the clips is visible. FIG. 12B illustrates lower clips of the clamps of the receptacles 1200 being pivoted (e.g., via hinge around a second cross bar of the upper vertical frame. FIG. 12C illustrates the legs 1110 of the chair rack 1100 being placed into slots 1210 within the receptacle 1200 to secure the chair rack 1100. The legs 1110 and the slots 1210 may include some means of securing the two together (e.g., aligned pins and holes). FIG. 12D illustrates an umbrella holder 1220 being connected to a back side of the upper vertical frame that would be accessible to a user pushing the cart. The umbrella holder 1220 may include clips 1230 that clip onto an upper and a lower cross bar.

The types of modules that can be secured to the lower and upper frames 110, 130 is in no way limited to the modules described and illustrated above. Furthermore, the arrangement of modules and number of modules utilized is in no way limited to the illustrated embodiments. Rather, any number, type and arrangement of modules could be utilized as long as any internal modules are capable of being collapsible for storage.

Although the invention has been illustrated by reference to specific embodiments, it will be apparent that the invention is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

1. A multi-purpose pushcart comprising a lower horizontal frame having side frame members and a plurality of equally spaced cross bars between the side frame members, wherein the lower horizontal frame includes a pair of receptacles for receiving a pair of front wheel assembles and a pair of brackets for receiving a pair of back wheels;
an upper vertical frame having side frame members and a plurality of equally spaced cross bars between the side frame members, wherein the cross bars of the lower horizontal frame and the upper vertical frame are configured to enable any number of modules to be secured thereto, wherein the modules are configured to secure to one or more cross bars, and wherein the modules are capable of providing a desired function; and
a pivoting connector to secure a first end of the lower horizontal frame and a first end of the upper vertical frame together, wherein the pivoting connector is capable of securing the lower horizontal frame and the upper vertical frame in an open configuration where they are perpendicular to one another or enabling a second end of the upper vertical frame to pivot toward a second end of the the lower horizontal frame so they are parallel to one another in a closed configuration.

2. The pushcart of claim 1, further comprising
a pair of front wheel assembles connectable to the pair of receptacles;
a pair of rear wheels connectable to the pair of brackets.

3. The pushcart of claim 1, further comprising a module connectable to one or more cross bars of the upper vertical frame and extending inward therefrom.

4. The pushcart of claim 3, wherein
the module is configured to extend perpendicular from the upper vertical frame or pivot downward to extend substantially parallel to the upper vertical frame,
the module extends perpendicular from the upper vertical frame in the open configuration of the cart so the module can be utilized, and
the module extends parallel to the upper vertical frame when not in use so that the cart can be pivoted to the closed configuration.

5. The pushcart of claim 4, wherein the module is a storage basket.

6. The pushcart of claim 4, wherein the module is a pet caddy.

7. The pushcart of claim 3, wherein the module is a chair rack.

8. The pushcart of claim 3, wherein the module includes at least one clamp for securing to adjacent bars.

9. The pushcart of claim 8, wherein the at least one clamp includes clips on adjacent sides, and one of the clips is hinged to enable securing of the at least one clamp to the adjacent bars.

10. The pushcart of claim 8, wherein the at least one clamp includes a pivoting receptacle to enable the module to pivot between being perpendicular to the upper vertical frame in the open configuration of the cart so the module can be utilized and being parallel to the upper vertical frame when not in use so that the cart can be pivoted to the closed configuration.

11. The pushcart of claim 1, further comprising a storage bin on the lower horizontal frame, wherein the storage bin includes a pivotal exterior wall connected to one or more cross bars of the lower horizontal frame and material secured to the lower horizontal frame, the upper vertical frame and the pivotal exterior wall to form the storage bin, wherein the storage bin is open and accessible when the pivotal exterior wall extends upward from the lower horizontal frame and is collapsed when the pivotal exterior wall is pivoted to be parallel to the lower horizontal frame.

12. A multi-purpose pushcart comprising a lower horizontal frame having side frame members and a plurality of equally spaced cross bars between the side frame members;
an upper vertical frame having side frame members and a plurality of equally spaced cross bars between the side frame members;
a pivoting connector to secure a first end of the lower horizontal frame and a first end of the upper vertical frame together, wherein the pivoting connector is capable of securing the lower horizontal frame and the upper vertical frame in an open configuration where they are perpendicular to one another or enabling a second end of the upper vertical frame to pivot toward a second end of the the lower horizontal frame so they are parallel to one another in a closed configuration;
a pair of front wheel assembles connected to the lower horizontal frame and capable of moving in different directions;
a pair of rear wheels connected to the lower horizontal frame; and
a module connected to one or more of the cross bars of the upper vertical frame and extending inward therefrom, wherein the module is capable of providing a desired function.

13. The pushcart of claim 12, wherein
the module is configured to extend perpendicular from the upper vertical frame or pivot downward to extend substantially parallel to the upper vertical frame,
the module extends perpendicular from the upper vertical frame in the open configuration of the cart so the module can be utilized, and
the module extends parallel to the upper vertical frame when not in use so that the cart can be pivoted to the closed configuration.

14. The pushcart of claim 13, wherein the module is one of a storage basket and a pet caddy.

15. The pushcart of claim 13, wherein the module includes at least one clamp for securing to adjacent cross bars and a device secured to the clamp for providing the desired function, wherein the at least one clamp includes a pivoting receptacle to receive the device and enable the device to pivot between extending perpendicular and extending parallel.

16. The pushcart of claim 15, wherein the at least one clamp includes a stationary clip on a first end to secure to a first cross bar and a hinged clip on a second end to be pivotally secured to a second cross bar after the first clip is secured to the first cross bar.

17. The pushcart of claim 12, further comprising a storage bin located on the lower horizontal frame, wherein the storage bin includes a pivotal exterior wall connected to one or more cross bars, wherein the pivotal exterior wall opens the storage bin when the pivotal exterior wall extends upward from the lower horizontal frame and collapses the storage bin when the pivotal exterior wall is pivoted to be parallel to the lower horizontal frame.

18. A multi-purpose pushcart comprising
a lower horizontal frame having side frame members and a plurality of equally spaced cross bars between the side frame members;
an upper vertical frame having side frame members and a plurality of equally spaced cross bars between the side frame members;
a pivoting connector to secure a first end of the lower horizontal frame and a first end of the upper vertical frame together, wherein the pivoting connector is capable of securing the lower horizontal frame and the upper vertical frame in an open configuration where they are perpendicular to one another or enabling a second end of the upper vertical frame to pivot toward a second end of the the lower horizontal frame so they are parallel to one another in a closed configuration;
a pair of front wheel assembles connected to the lower horizontal frame and capable of moving in different directions;
a pair of rear wheels connected to the lower horizontal frame;
a storage bin located on, and secured to the lower horizontal frame and secured to a lower portion of the upper vertical frame, wherein the storage bin includes a pivotal exterior wall connected to one or more cross bars of the lower horizontal frame, wherein the storage bin is open and accessible when the pivotal exterior wall extends upward from the lower horizontal frame and is collapsed when the pivotal exterior wall is pivoted to be parallel to the lower horizontal frame; and
a module to provide a desired function connected to one or more of the cross bars of the upper vertical frame and extending inward therefrom, wherein the module is configured to extend perpendicular from the upper vertical frame in the open configuration of the cart so the module can be utilized or pivot downward to pivot downward so as to extend substantially parallel to the upper vertical frame when not in use so that the cart can be pivoted to the closed configuration.

19. The pushcart of claim 18, wherein the module includes at least one clamp for securing to adjacent bars and a device secured to the clamp for providing the desired function, wherein the at least one clamp includes a pivoting receptacle to enable the device to pivot between extending perpendicular and extending parallel.

20. The pushcart of claim 19, wherein the at least one clamp includes a stationary clip on a first end to secure to a first cross bar and a hinged clip on a second end to be pivotally secured to a second cross bar after the first clip is secured to the first cross bar.
